(19) United States
(12) Patent Application Publication
(10) Pub. No.: US 2025/0189934 A1
(43) Pub. Date: Jun. 12, 2025

(54) MICROFABRICATED ALKALINE EARTH VAPOR CELL AND METHOD OF FABRICATION

(71) Applicants: THE REGENTS OF THE UNIVERSITY OF COLORADO, A BODY CORPORATE, Denver, CO (US); GOVERNMENT OF THE UNITED STATES OF AMERICA, AS REPRESENTED BY THE SECRETARY OF COMMERCE, GAITHERSBURG, MD (US)

(72) Inventors: JACOB M. PATE, LONGMONT, CO (US); MATTHEW T. HUMMON, GOLDEN, CO (US); JOHN KITCHING, Boulder, CO (US)

(21) Appl. No.: 18/844,011

(22) PCT Filed: Mar. 5, 2023
(86) PCT No.: PCT/US2023/014557

§ 371 Date: Sep. 4, 2024

Related U.S. Application Data
(60) Provisional application No. 63/268,922, filed on Mar. 5, 2022.

(51) Int. Cl. G04F 5/14

(52) U.S. Cl. CPC G04F 5/14

(57) ABSTRACT

An atomic vapor cell includes a bottom transparent substrate having a floor surface, a top transparent substrate having a ceiling surface, a frame, a bottom protective layer, a top protective layer, and an alkaline earth metal between the bottom and the top transparent substrates. The frame has a bottom surface bonded to the floor surface, a top surface opposite the bottom surface and bonded to the ceiling surface, a reservoir hole, an aperture, and a channel that connects the reservoir hole to the aperture. The top protective layer is on the ceiling surface and includes layer-regions that cover respective regions of the ceiling surface spanning across the reservoir hole and the aperture. The bottom protective layer is on the floor surface and includes a layer-region that covers a region of the floor surface that spans across the aperture. The alkaline earth metal is in the reservoir hole.

### CROSS-REFERENCE TO RELATED APPLICATIONS

This application claims the benefit of U.S. Provisional Application No. 63/268,922, filed on Mar. 5, 2022, the disclosure of which is incorporated herein by reference in its entirety.

### GOVERNMENT RIGHTS

This invention was made with government support under grant number 70NANB18H006 awarded by NIST. The government has certain rights in the invention.

### SUMMARY

In a first aspect, an atomic vapor cell is disclosed. The vapor cell includes a bottom transparent substrate having a floor surface, a top transparent substrate having a ceiling surface, a frame, a bottom protective layer, a top protective layer, and an atomic-vapor source. The frame has (i) a bottom surface bonded to the floor surface, (ii) a top surface opposite the bottom surface and bonded to the ceiling surface, (iii) a reservoir hole, (iv) a probe aperture, and (iv) a channel that connects the reservoir hole to the probe aperture. The top protective layer is on the ceiling surface and includes a first layer-region and a second layer-region that cover respective regions of the ceiling surface spanning across the reservoir hole and the probe aperture. The bottom protective layer is on the floor surface and includes a third layer-region that covers a region of the floor surface that spans across the probe aperture. The atomic-vapor source (i) includes an alkaline earth metal and (ii) is located in the reservoir hole and between the bottom and the top transparent substrates.

In a second aspect, a vapor-cell fabrication method is disclosed. The method includes: loading an atomic-vapor source into a chamber of an unsealed atomic vapor cell to yield a loaded vapor cell; and sealing the loaded atomic vapor cell by bonding a top window to the unsealed atomic vapor cell.

### BRIEF DESCRIPTION OF THE FIGURES

FIG. 1 is a schematic of a vapor cell, in an embodiment.

FIG. 2 is a graph illustrating frequency as a function of absorption for strontium, according to an embodiment.

FIGS. 3 and 4 are respective schematics of an embodiment of a vapor cell, of which vapor cell of FIG. 1 is an example.

FIG. 5 is a cross-sectional view of the vapor cell of FIG. 4.

FIG. 6 is a cross-sectional view of a frame, which is an example of the frame of FIG. 4 that includes an inter-frame protective layer, in an embodiment.

FIG. 7 is a schematic of a transparent substrate that has a protective coating thereon, in an embodiment.

FIG. 8 is a flowchart illustrating a method for fabricating the vapor cell of FIG. 3, in an embodiment.

FIGS. 9 and 10 are respective schematics of an embodiment of a vapor cell, of which vapor cell of FIG. 1 is an example.

FIG. 11 is a cross-sectional view of the vapor cell of FIG. 10.

FIG. 12 is a cross-sectional view of a frame, which is an example of the frame of FIG. 10 that includes an inter-frame protective layer, in an embodiment.

### DETAILED DESCRIPTION OF THE EMBODIMENTS

Embodiments of the present disclosure include a method and system for fabricating a functional microfabricated strontium (Sr) atomic vapor cell. As opposed to the conventional method that requires substantial resources, and Sr atomic vapor cell creates a miniature, stable, and low-cost optical frequency reference. Experiments have operated these chip-scale atomic cells at temperatures above 300 degrees Celsius for over 380 hours with 25 separate thermal cycles.

The identical nature of atoms of the same element provides a strong basis for universal timekeeping, metrology, and sensing across the world and beyond into space exploration. The SI unit of the second is currently defined by the frequency of the Cesium hyperfine ground state splitting and the future redefinition of the second will likely move toward optical wavelength atomic transitions since clocks based on these have a much lower fractional frequency instability and inaccuracy. Many major advancements in atomic clocks require large, expensive facilities to maintain frequency standards and are subsequently out of direct reach for much of the scientific community. As a result, significant efforts in the past few decades have pushed the atomic physics technology of accurate timekeeping and frequency measurements into smaller packages with lower power consumption and manufacturing cost. The field has subsequently become known as chip-scale atomic clock (CSAC) and uses contemporary silicon microfabrication techniques and photonics.

Atomic vapors confined within small packages are not only useful for timekeeping, but also offer competitive advantages as sensors. For example, Rydberg atoms confined in vapor cells are useful for sensing external fields due to the high electric polarizabilities of the atoms being probed. Atomic vapor cells have been used to create Rydberg atoms and have demonstrated their capability in detecting microwave fields in both magnitude and phase. Other groups have used these atomic vapors to store and stop light using electromagnetically-induced transparency. Atomic magnetometers based on vapor cells have also been used in a wide range of applications such as magnetoencephalographic measurements of the human brain, gyroscopes for navigation, mapping of subterranean features, and even identifying explosive devices.

While microwave frequency standards such as the atomic beam or fountain clocks provide good stability and accuracy, transitioning to optical standards results in further improvement of these quantities. Among the optical frequency references, strontium, an alkali-earth metal, is a competing candidate because it has a transitions with a range of linewidths, from tens of megahertz to millihertz. Strontium has also generated much interest as a platform for quantum computing. Alkali-earth metals are generally challenging to work with because of the lower vapor pressures and therefore require higher operating temperatures to reach sufficient light absorption in spectroscopy. Recently developed techniques have demonstrated room-temperature production of alkaline earth atoms in the vapor phase using, for example, light-induced atomic desorption (LIAD) and heating of oxidized alkali-earth metal. Present embodiments allow alkali-earth elements such as strontium in the vapor phase to be generated with miniaturized packaging and microfabrication processes.

Vapor pressures of alkali-earth elements are much lower than those of alkali metals and, therefore, much higher temperatures are needed to achieve the same sufficient vapor pressures and absorptions. In other words, a source requires a higher temperature to reach higher vapor pressure to achieve absorption of an optical beam 108.

FIG. 1 is a schematic of vapor cell 100 manufactured in a cleanroom on a 3 mm thick silicon wafer 130 and features two individual chambers. A reservoir chamber 133 (3 mm×5 mm) houses strontium metal 160 and is connected to the optical probe chamber 135 (6 mm×5 mm) through baffles 134 angled (e.g., at 45 degrees). Baffles 134 are defined by angled sidewalls that prevent line-of-sight access between chambers 133 and 135, such that an atomic beam cannot propagate between chambers 133 and 135.

Vapor cell 100 may be sealed via anodic bonding, vacuuming through the thin layer of Al₂O₃. Vapor cell 100 may be bonded under vacuum at between 300-400 degrees Celsius with 1,000 V potential. Due to quick oxidation of strontium when exposed to water or oxygen, metal is loaded into reservoir chamber 133 under an argon atmosphere, quickly transferred in air to the wafer bonder (not shown) which is subsequently pumped down. The transfer process usually takes less than one minute.

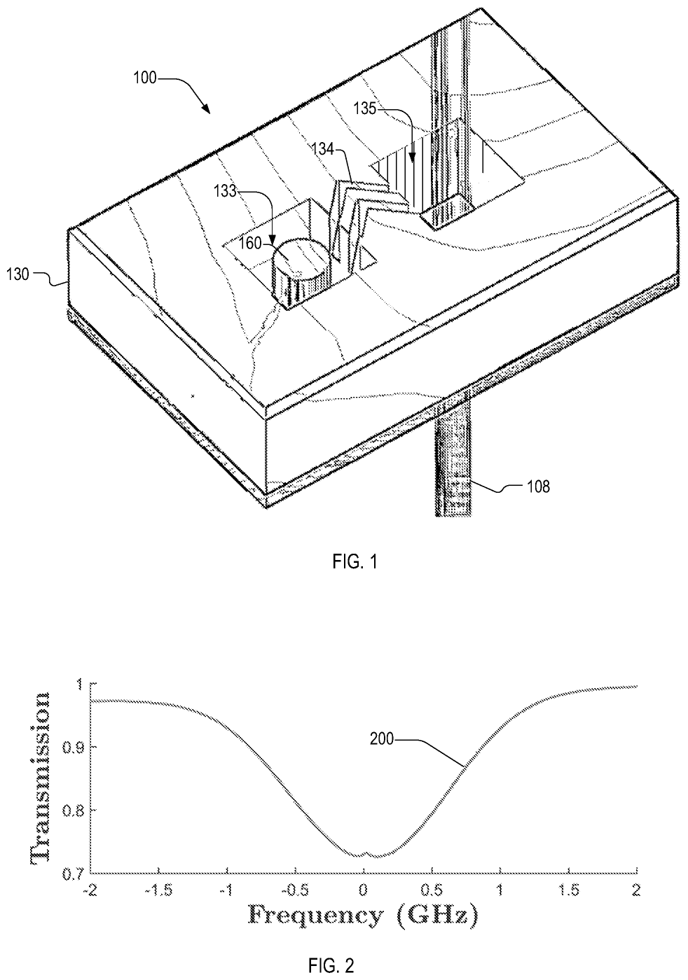

FIG. 2 is a graph illustrating a strontium absorption spectrum 200 near 461 nm in vapor cell 100 of FIG. 1 held at an operating temperature around 320° C. Spectrum 200 shows a wide Doppler-broadened feature with a width of about 1 GHz and absorption of the order of 25%, and a smaller sub-Doppler resonance near zero detuning with a width near 30 MHz, generated from the counterpropagating pump beam. This curve depicts the main absorption with no averaging and is representative of typical data. Assuming a 3-mm long absorption path length, from the 25% Doppler-broadened absorption we estimate a Sr density of 4×10¹⁰ cm⁻³, corresponding to an equilibrium vapor pressure temperature of 325° C., consistent with the estimated oven temperature.

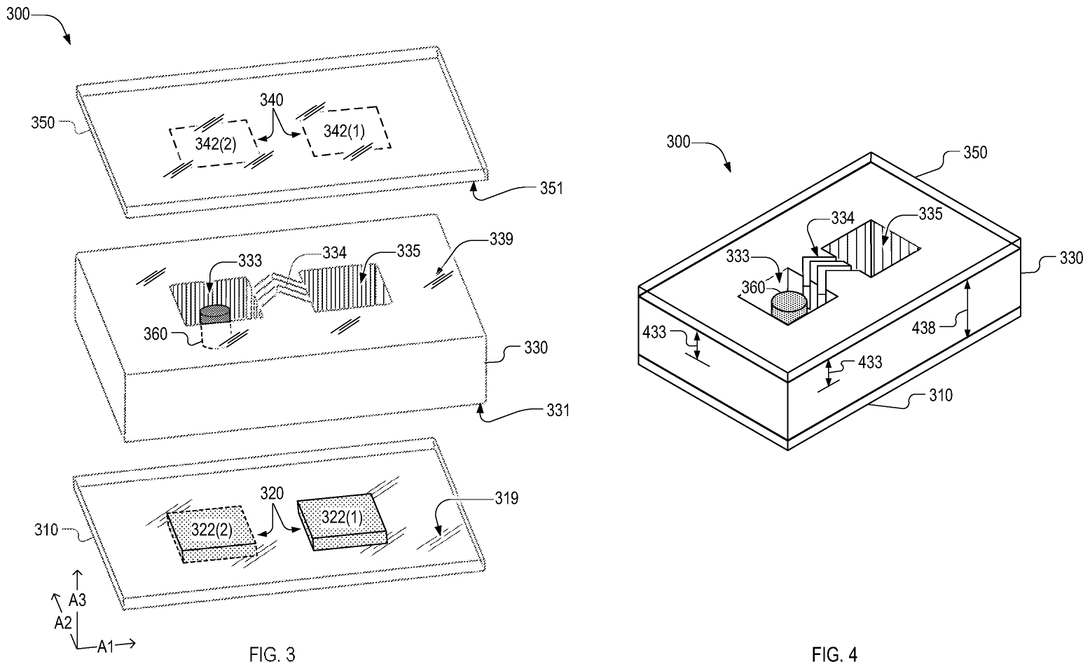

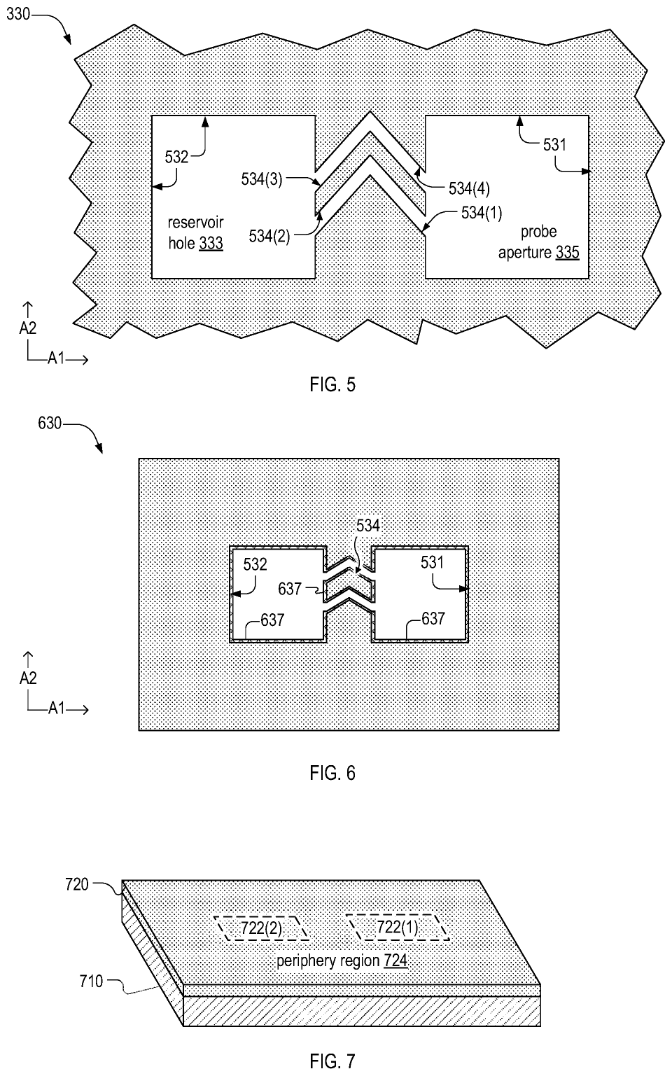

FIG. 3 is an exploded schematic, and FIG. 10 is an isometric view, of a vapor cell 300, of which vapor cell 100 is an example. FIG. 5 is a cross-sectional view of vapor cell 300. FIGS. 3-5 are best viewed together in the following description. For clarity of illustration, atomic-vapor source 360 is not shown in FIG. 5.

Figures herein depict orthogonal axes A1, A2, and A3, also referred to as the x axis, y axis, and z axis, respectively. Herein, the x-y plane is formed by orthogonal axes A1 and A2, and planes parallel to the x-y plane are referred to as transverse planes. Unless otherwise specified, heights and depths of objects herein refer to the object's extent along axis A3. Also, herein, a horizontal plane is parallel to the x-y plane, a width refers to an object's extent along the x or y axis respectively, and a vertical direction is along the z axis.

Vapor cell 300 includes transparent substrates 310 and 350, a frame 330, protective layers 320 and 340, and an atomic-vapor source 360. Bottom transparent substrate 310 has a floor surface 319. Top transparent substrate 350 has a ceiling surface 351. Frame 330 has (i) a bottom surface 331 bonded to floor surface 319, (ii) a top surface 339 opposite bottom surface 331 and bonded to ceiling surface 351, (iii) a reservoir hole 333, (iv) a probe aperture 335, and (iv) a channel 334 that connects the reservoir hole to the probe aperture. In embodiments, frame 330 is formed of one of silicon, glass, a ceramic, or a combination thereof. Substrates 310 and 350 may be formed of glass, such as borosilicate glass or aluminosilicate glass.

Frame 330 has a thickness 438. FIG. 10 denotes a vertical depth 433 beneath top surface 339. Reservoir hole 333 may be a through hole or a blind hole. When reservoir hole 333 is a blind hole, vertical depth 433 is less than a vertical depth of reservoir hole 333. The cross-sectional plane of FIG. 5 is in a horizontal plane located at vertical depth 433. This plane intersects reservoir hole 333 and probe aperture 335. Reservoir chamber 133 and chamber 135 are respective examples of reservoir hole 333 and probe aperture 335 that are each sealed by transparent substrates 310 and 350 bonded to frame 330.

Protective layer 320 is on floor surface 319, and includes a layer-region 322(1), which covers a region of floor surface 319 that spans across probe aperture 335. Protective layer 320 may also include a layer-region 322(2), which covers a region of floor surface 319 that is directly beneath reservoir hole 333. When reservoir hole 333 is a through hole, layer-region 322(2) spans across reservoir hole 333. Protective layer 340 is on ceiling surface 351 and includes layer-region 342(2) and 342(1), which cover respective regions of ceiling surface 351 spanning across the reservoir hole 333 and probe aperture 335, respectively. Materials constituting protective layers 320 and 340 may include aluminum oxide, diamond, and a combination thereof.

Bottom surface 331 and top surface 339 are bonded to floor surface 319 and ceiling surface 351, respectively. The type of bonding may be one of anodically bonding, fusion bonding, eutectic bonding, optical contact bonding, and hydrogen catalysis bonding.

Along axes A3, protective layers 320 and 340 have a thickness, which may exceed twenty nanometers to ensure that that protective layers adequately protect transparent substrates 310 and 350. The thickness may be less than fifty nanometers. This upper limit ensures that, when parts of protective layers 320 and 340 are between frame 330 and respective transparent substrates 310 and 350, frame 330 can be anodically bonded to substrates 310 and 350 through protective layers 320 and 340, respectively.

Atomic-vapor source 360 includes an alkaline earth metal, is located in reservoir hole 333, and is between transparent substrates 310 and 350. Atomic-vapor source 360 may include one or more of beryllium, magnesium, calcium, strontium, barium, and radium.

Frame 330 has an interior surface 531, an interior surface 532, and channel surfaces 534(1,2), which define, probe aperture 335, reservoir hole 333, and channel 334 respectively, as shown in FIG. 5. To illustrate details of surfaces 532, 531, and 534, FIG. 5 does not illustrate the full spatial dimensions of frame 330 in directions A1 and A2. Frame 330 may include just one channel 334, or one or more additional channels 334, e.g., a channel 334 defined by interior surfaces 534(3,4). In embodiments, at least one of surfaces 534(1) and 534(2) is non-planar such that channel 334 is optically occluded, which herein means that it lacks a line-of-sight therethrough. Channel 334's being optically occluded prevents an atomic beam from propagating from atomic-vapor source 360 to probe aperture 335. FIG. 5 illustrates this optical occlusion, as there is no linear path through channel 334 from reservoir hole 333 and probe aperture 335.

When reservoir hole 333 is a blind hole, interior surface 532 is a concave surface between bottom surface 331 and top surface 339. When reservoir hole 333 is a through hole, interior surface 532 spans between bottom surface 331 and top surface 339. Interior surface 531 spans between bottom surface 331 and top surface 339. Channel surface 534 spans between interior surface 532 and 531, and is between bottom surface 331 and top surface 339.

In embodiments, frame 330 includes an inter-frame protective layer covering surfaces 532, 531, and 534. For example, FIG. 6 is a cross-sectional view of a frame 630, which is an example of frame 330 that includes an inter-frame protective layer 637 on surfaces 532, 531, and 534. Materials constituting protective layer 637 may include aluminum oxide, diamond, and a combination thereof. For clarity of illustration, FIG. 6 does not include atomic-vapor source 360.

FIG. 7 is a schematic of a transparent substrate 710 that has a protective coating 720 thereon. Substrate 710 is an example of each of transparent substrates 310 and 350. Protective coating 720 is an example of each of protective layers 320 and 340. Protective coating 720 may be a single continuous layer of material on a top surface of transparent substrate 710. Examples of the material forming coating 720 include aluminum oxide, diamond, and combinations thereof.

FIG. 7 denotes three regions of protective coating 720: central regions 722(1) and 722(2), and a periphery region 724. When vapor cell 300 includes protective coating 720 on transparent substrate 310, frame 330 may be bonded to floor surface 319 through periphery region 724. Similarly, when vapor cell 300 includes protective coating 720 on transparent substrate 350, frame 330 may be bonded to ceiling surface 351 through periphery region 724.

Central region 722(1) is an example of layer-regions 322(1) and 342(1). Central region 722(2) is an example of layer-regions 322(2) and 342(2). A benefit of a protective coating 720 is that it may be formed with fewer fabrication steps than a coating that includes only layer-regions 322 or layer regions 342. In embodiments, periphery region 724 has a thickness between twenty nanometers and fifty nanometers. The reasons for these upper and lower limits are the same as those described above for protective layers 320 and 340.

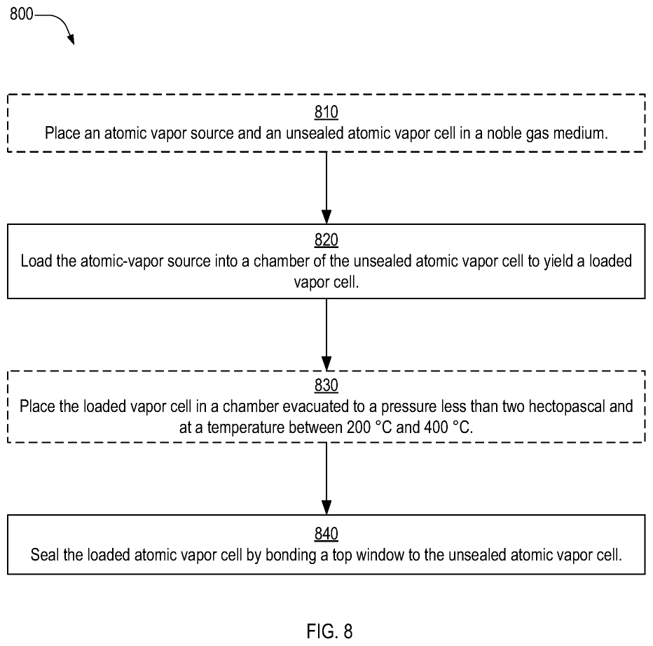

FIG. 8 is a flowchart illustrating a method 800 for fabricating a vapor cell, such as vapor cell 300. Method 800 includes step 820 and 840, and may also include at least one of steps 810 and 830.

Step 820 includes loading an atomic-vapor source into a chamber of an unsealed atomic vapor cell to yield a loaded vapor cell. In an example of step 820, the unsealed vapor cell is vapor cell 300 in which transparent substrate 350 is not bonded to frame 330, such that reservoir hole 333 is accessible. In this example, atomic-vapor source 360 is loaded into reservoir hole 333. In embodiments, step 820 includes loading an alkali metal precursor into the chamber. In such embodiments, method 800 may also include, as part of step 820 or step 830 for example, subjecting the alkali metal precursor to a reaction stimulus (such as heat) to yield an alkali metal that functions as the atomic-vapor source.

Step 810 precedes step 820, and includes placing the atomic vapor source and the unsealed atomic vapor cell in a noble gas medium, wherein step 820 is performed in the noble gas medium. The noble gas medium may lack both oxygen and water, as such species oxidize the atomic vapor source. In an example of step 810, atomic-vapor source 360 and vapor cell 300 (without transparent substrate 350) are placed in a glovebox filled with a noble gas, such as argon.

Step 830 follows step 820 and precedes step 840. Step 830 includes placing the loaded vapor cell in a chamber evacuated to a pressure less than two hectopascal and at a temperature between 200° C. and 400° C. In an example of step 830, vapor cell 300 is placed in a bonding chamber that satisfies the pressure and temperature requirements of step 830. In embodiments, the pressure is less than 2×10⁻⁴ hectopascal.

Step 840 includes sealing the loaded atomic vapor cell by bonding a top window to the unsealed atomic vapor cell. In an example of step 840, transparent substrate 350 is bonded to top surface 339 of frame 330, which seals vapor cell 300. The bonding of step 840 may include one or more of anodically bonding, fusion bonding, eutectic bonding, optical contact bonding, and hydrogen catalysis bonding. Step 840 may also include at least one of (i) maintaining a temperature of the unsealed atomic vapor cell between 200° C. and 400° C., and (ii) applying a voltage across the interface between frame 330 and transparent substrate 350. The voltage may be at least one kilovolt. For increased ion mobility in transparent substrate 350 the temperature may exceed 300° C.

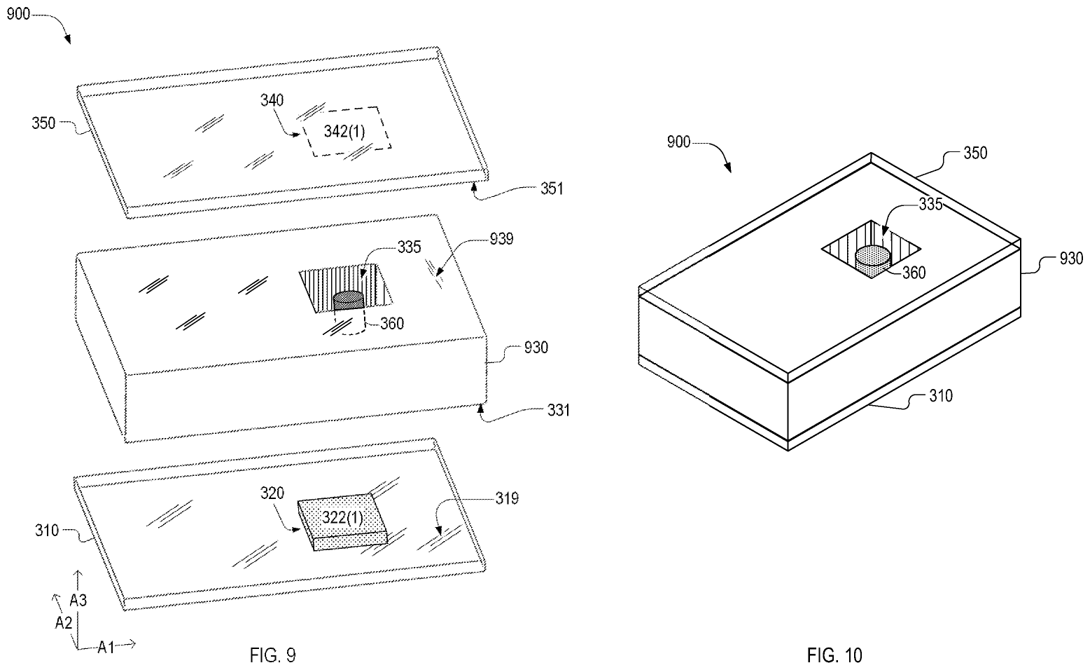

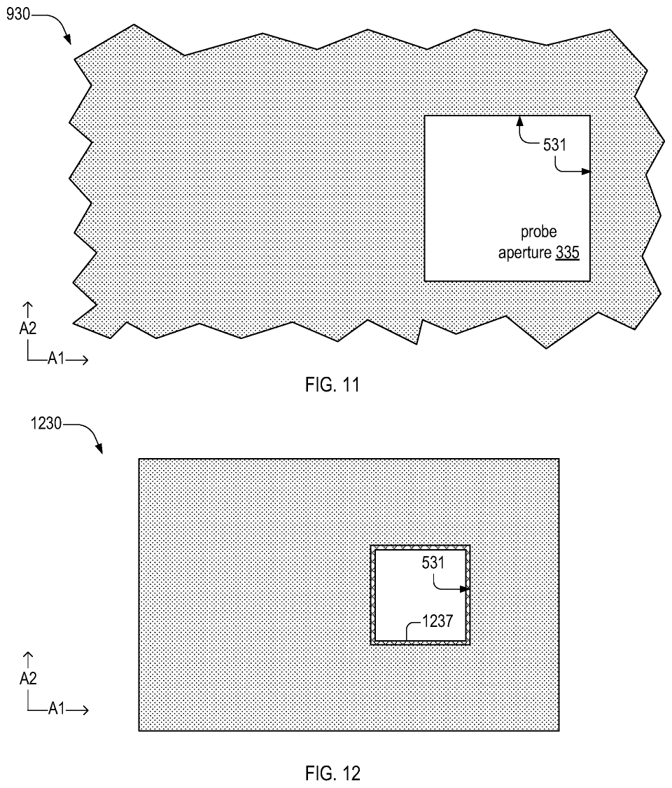

FIG. 9 is an exploded schematic, and FIG. 10 is an isometric view, of a vapor cell 300, which is similar to vapor cell 300 with no reservoir hole 333. Rather, atomic-vapor source 360 in probe aperture 935 of vapor cell 900. FIG. 11 is a cross-sectional view of vapor cell 900 in a horizontal plane. FIGS. 9-11 are best viewed together in the following description. For clarity of illustration, atomic-vapor source 360 is not shown in FIG. 11.

Vapor cell 900 includes transparent substrates 310 and 350, a frame 930, protective layers 320 and 340, and atomic-vapor source 360. Frame 330 is an example of frame 930 that includes reservoir hole 333. Frame 930 has (i) a bottom surface 931 bonded to floor surface 319, (ii) a top surface 939 opposite bottom surface 331 and bonded to ceiling surface 351, and (iii) probe aperture 935. In embodiments, frame 930 is formed of one of silicon, glass, a ceramic, or a combination thereof.

Bottom surface 931 and top surface 939 are bonded to floor surface 319 and ceiling surface 351, respectively. The type of bonding may be one of anodically bonding, fusion bonding, eutectic bonding, optical contact bonding, and hydrogen catalysis bonding.

Frame 930 has an interior surface 531, which probe aperture 335, as shown in FIG. 11. In embodiments, frame 930 includes an inter-frame protective layer covering surface 531. For example, FIG. 12 is a cross-sectional view of a frame 1230, which is an example of frame 930 that includes an inter-frame protective layer 1237 on surface 531. Materials constituting protective layer 637 may include aluminum oxide, diamond, and a combination thereof. For clarity of illustration, FIG. 12 does not include atomic-vapor source 360.

We claim:

1. An atomic vapor cell, comprising:
a bottom transparent substrate having a floor surface;
a top transparent substrate having a ceiling surface;
a frame having (i) a bottom surface bonded to the floor surface, (ii) a top surface opposite the bottom surface and bonded to the ceiling surface, (iii) a reservoir hole, (iv) a probe aperture, and (iv) a channel that connects the reservoir hole to the probe aperture;
a top protective layer on the ceiling surface and including a first layer-region and a second layer-region that cover respective regions of the ceiling surface spanning across the reservoir hole and the probe aperture;
a bottom protective layer on the floor surface and including a third layer-region that covers a region of the floor surface that spans across the probe aperture; and
an atomic-vapor source that (i) includes an alkaline earth metal and (ii) is located in the reservoir hole and between the bottom and the top transparent substrates.

2. The atomic vapor cell of claim 1, the bottom protective layer including a bottom periphery region that (i) surrounds the third layer-region and (ii) is between the floor surface and the frame, such that the frame is bonded to the floor surface through the bottom periphery region.

3. The atomic vapor cell of claim 1, the reservoir hole being a through hole, the bottom protective layer further including a fourth layer-region that covers a region of the floor surface that spans across the reservoir hole.

4. The atomic vapor cell of claim 3, the bottom protective layer including a bottom periphery region that (i) surrounds each of the third and the fourth layer-regions and (ii) is between the floor surface and the frame, such that the frame is bonded to the floor surface through the bottom periphery region.

5. The atomic vapor cell of claim 4, a thickness of the bottom periphery region being between twenty nanometers and fifty nanometers.

6. The atomic vapor cell of claim 1, the top protective layer including a top periphery region that (i) surrounds each of the first and the second layer-regions and (ii) is between the floor surface and the frame, such that the frame is bonded to the ceiling surface through the top periphery region.

7. The atomic vapor cell of claim 6, a thickness of the top periphery region being between twenty nanometers and fifty nanometers.

8. The atomic vapor cell of claim 1, the frame being formed of one of silicon, glass, a ceramic, or a combination thereof.

9. The atomic vapor cell of claim 1, each of the bottom protective layer and the top protective layer including one of aluminum oxide, diamond, and a combination thereof.

10. The atomic vapor cell of claim 1, the alkaline earth metal being strontium.

11. The atomic vapor cell of claim 1, the channel being optically occluded such that it lacks a line-of-sight therethrough.

12. The atomic vapor cell of claim 1, the reservoir hole being one of a blind hole and a through hole, the frame having:
a first interior surface that defines the reservoir hole and being one of (i) when the reservoir hole is a blind hole, a concave surface between the top surface and the bottom surface, and (ii) when the reservoir hole is the through hole, a first interior surface spanning between the top surface and the bottom surface;
a second interior surface that defines the probe aperture and spans between the top surface and the bottom surface; and
a channel surface that (i) defines the channel, (ii) spans between the first and the second interior surface, and (iii) is between the bottom surface and the top surface.

13. The atomic vapor cell of claim 12, further comprising an inter-frame protective layer covering the first interior surface, the second interior surface, and the channel surface.

14. The atomic vapor cell of claim 13, the inter-frame protective layer including one of aluminum oxide, diamond, and a combination thereof.

15. An atomic vapor cell comprising:
a bottom transparent substrate having a floor surface;
a top transparent substrate having a ceiling surface;
a frame having (i) a bottom surface bonded to the floor surface, (ii) a top surface opposite the bottom surface and bonded to the ceiling surface, and (iii) a probe aperture;
a top protective layer on the ceiling surface and including a first layer-region that covers a region of the ceiling surface spanning across the probe aperture;
a bottom protective layer on the floor surface and including a second layer-region that covers a region of the floor surface that spans across the probe aperture; and
an atomic-vapor source that (i) includes an alkaline earth metal and (ii) is located in the probe aperture and between the bottom and the top transparent substrates.

16. A vapor-cell fabrication method, comprising:
loading an atomic-vapor source into a chamber of an unsealed atomic vapor cell to yield a loaded vapor cell; and
sealing the loaded atomic vapor cell by bonding a top window to the unsealed atomic vapor cell.

17. The method of claim 16, further comprising, before loading, placing the atomic-vapor source and the unsealed atomic vapor cell in a noble gas medium, said loading being performed in the noble gas medium.

18. The method of claim 16, further comprising, after loading and before bonding, placing the loaded vapor cell in a chamber evacuated to a pressure less than two hectopascal and at a temperature between 200° C. and 400° C.

19. The method of claim 18, in said step of loading, the atomic-vapor source including one of an alkali metal and an alkali metal precursor.

20. The method of claim 16, bonding comprising one of anodically bonding, fusion bonding, eutectic bonding, optical contact bonding, and hydrogen catalysis bonding.
